(19) United States
(12) Patent Application Publication
(10) Pub. No.: US 2020/0305641 A1
(43) Pub. Date: Oct. 1, 2020

(54) RACK ASSEMBLY

(71) Applicant: Electrolux Home Products, Inc., Charlotte, NC (US)

(72) Inventors: Steven M. Swayne, Springfield, TN (US); Stephanie Phillips, Woodburn, KY (US); Brendan McGinnis, Russellvillle, KY (US); Andrew Worley, Springfield, TN (US)

(21) Appl. No.: 16/369,341

(22) Filed: Mar. 29, 2019

(51) Int. Cl. A47J 37/06; F24C 15/16; B23P 19/04; A47J 36/22; A23L 5/10; A47J 36/38

(52) U.S. Cl. CPC A47J 37/0694; F24C 15/16; B23P 19/04; A23V 2002/00; A23L 5/15; A47J 36/38; A47J 36/22

(57) ABSTRACT

A rack assembly is mountable within a cooking cavity of an appliance. The rack assembly includes a slide rack defining a well opening and configured to removably support a rack insert in or through said well opening. A telescoping slide is coupled to said slide rack such that said slide rack is slidable between a fully retracted position and a forward position relative to said cooking cavity when mounted therein.

### FIELD OF THE INVENTION

The present invention relates to a rack assembly that is mountable within a cavity of an appliance, and more particularly, a rack assembly that interchangeably supports a plurality of rack inserts.

### BACKGROUND

Rack assemblies can be mounted within a cavity of an appliance for supporting various items within the cavity. For example, oven appliances often have one or more rack assemblies mounted within their oven cavities for supporting cookware, food, and other items, within the oven. Such rack assemblies typically comprise a rack body formed by a plurality of wires, which can be placed on ledges defined by side walls of the oven cavity. The wires of the rack body collectively form a support platform upon which cookware, food, and other items can be placed. The thermal mass of these wires increase the amount of energy needed to thermally regulate (e.g., heat) the oven cavity. Moreover, different-sized rack bodies are typically manufactured for different-sized oven cavities, which inhibits the ability to scale manufacture of the rack bodies.

### BRIEF SUMMARY OF THE INVENTION

In accordance with one aspect, a rack assembly is mountable within a cooking cavity of an appliance. The rack assembly includes a slide rack defining a well opening and configured to removably support a rack insert in or through the well opening. A telescoping slide is coupled to the slide rack such that the slide rack is slidable between a fully retracted position and a forward position relative to the cooking cavity when mounted therein.

In one example of the first aspect, the rack assembly further includes a plurality of rack inserts, each of the plurality of rack inserts being different from the others and being interchangeably supportable by the slide rack in or through the well opening. In one example, one or more of the plurality of rack inserts includes a pan, a tray, a basket, or a supplemental rack. In another example, one or more of the plurality of rack inserts has dimensions approximating dimensions of the well opening.

In another example of the first aspect, the slide rack is defined by a plurality of wires. In one example, the slide rack is planar and rectangular in shape. In another example, the plurality of wires defines a rectangular outer frame and a rectangular inner frame surrounding the well opening, the inner frame being coplanar with and spaced inward from the outer frame. In yet another example of the first aspect, the rack assembly further includes a base configured to mount the rack assembly in the cooking cavity, the slide rack being coupled to the base via the telescoping slide. In one example, the telescoping slide includes a main portion fixed to the base, and an extension portion fixed to the slide rack and slidably coupled to the main portion. In another example, the base is defined by a plurality of wires. In another example, the rack assembly further includes an auxiliary rack insert and an auxiliary support coupled to the base for removably supporting the auxiliary rack insert beneath the well opening in the slide rack when the slide rack is fully retracted. In one example, the auxiliary support is defined by a plurality of brackets, each the bracket having a vertical portion that extends downward from the base and a flange portion that extends inward from the vertical portion. In another example, the auxiliary rack insert has larger dimensions than the well opening. In yet another example, the auxiliary rack insert is a pan, and a method of cooking in a cooking cavity having the rack assembly includes the steps of filling the pan with water; placing a food item on the rack insert mounted in or through the well opening in the slide rack; and heating the cooking cavity to cook the food item on the rack insert therein, whereby drippings from the food item fall through the rack insert and into the water in the pan, thereby preventing the drippings from directly contacting dry surfaces within the cooking cavity and thus from generating smoke while cooking the food item. In one example, the food item is placed directly onto said rack insert with no intermediate cooking utensil or wrapping.

In still yet another example of the first aspect, the slide rack has a well opening area that is 50% or more of a total superficial area of the slide rack.

In another example of the first aspect, a cooking appliance includes a cooking cavity and the rack assembly mounted within the cooking cavity. The slide rack is fully received within the cooking cavity when in the filly retracted position and emerges at least partially from the cooking cavity when in the forward position. An area of the well opening is 50% or more of a total superficial area of the slide rack.

In accordance with a second aspect, a method of manufacturing cooking appliances includes supplying a first cooking appliance having a first cooking cavity with first horizontal dimensions; supplying a second cooking appliance having a second cooking cavity with second horizontal dimensions smaller than the first horizontal dimensions; supplying a rack assembly for the first cooking appliance, the rack assembly being configured to be mounted in the first cooking cavity and including a slide rack that defines a well opening therein and is configured to removably support a rack insert in or through the well opening, the slide rack having slide rack dimensions that approximate the first horizontal dimensions; and supplying a plurality of the rack inserts, identical to one another, having insert dimensions that approximate the second horizontal dimensions of the second cooking appliance as well as well opening dimensions of the well opening.

In one example of the second aspect, the method includes supplying the first cooking appliance to a first geographic market, and supplying the second cooking appliance to a second geographic market distinct from the first geographic market.

In another example of the second aspect, a first subset of the rack inserts is packaged respectively with individual units of the second cooking appliance, and a second subset of the rack inserts is packaged respectively with individual units of the rack assembly.

In yet another example of the second aspect, the slide rack has a well opening area that is 50% or more of a total superficial area of the slide rack.

### BRIEF DESCRIPTION OF THE DRAWINGS

FIG. 1 illustrates a perspective view of a first appliance having a first cavity and a rack assembly mounted within the cavity;

FIG. 2 illustrates an exploded view of the rack assembly;

FIG. 3A illustrates a slide rack of the rack assembly and a supplemental rack that is interchangeably supportable by the slide rack;

FIG. 3B illustrates a cooking pan that is interchangeably supportable by the slide rack of the rack assembly;

FIG. 3C illustrates a cooking tray that is interchangeably supportable by the slide rack of the rack assembly;

FIG. 3D illustrates a cooking basket that is interchangeably supportable by the slide rack of the rack assembly; and

FIG. 4 illustrates a perspective view of a second appliance having a second cavity, wherein the supplemental rack of FIG. 3A is mounted within the second cavity.

### DESCRIPTION OF EXAMPLE EMBODIMENTS

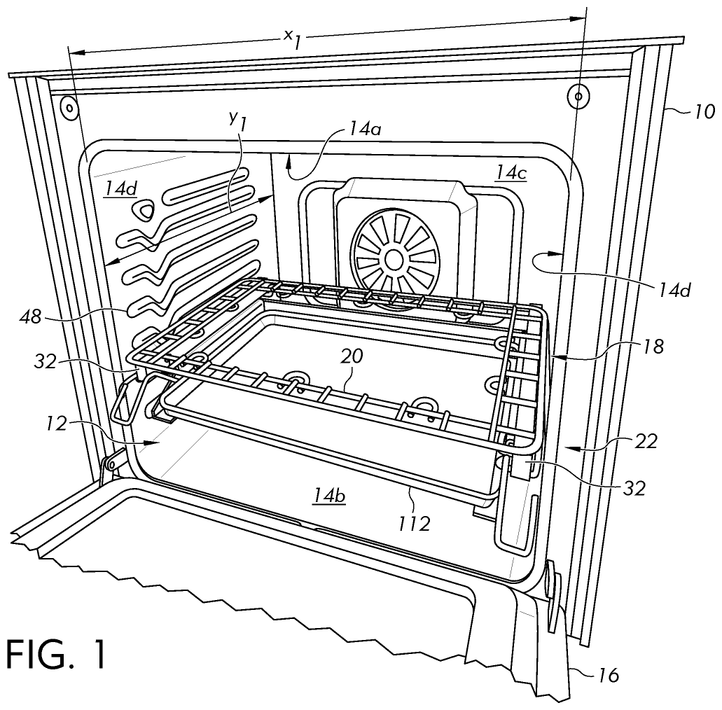

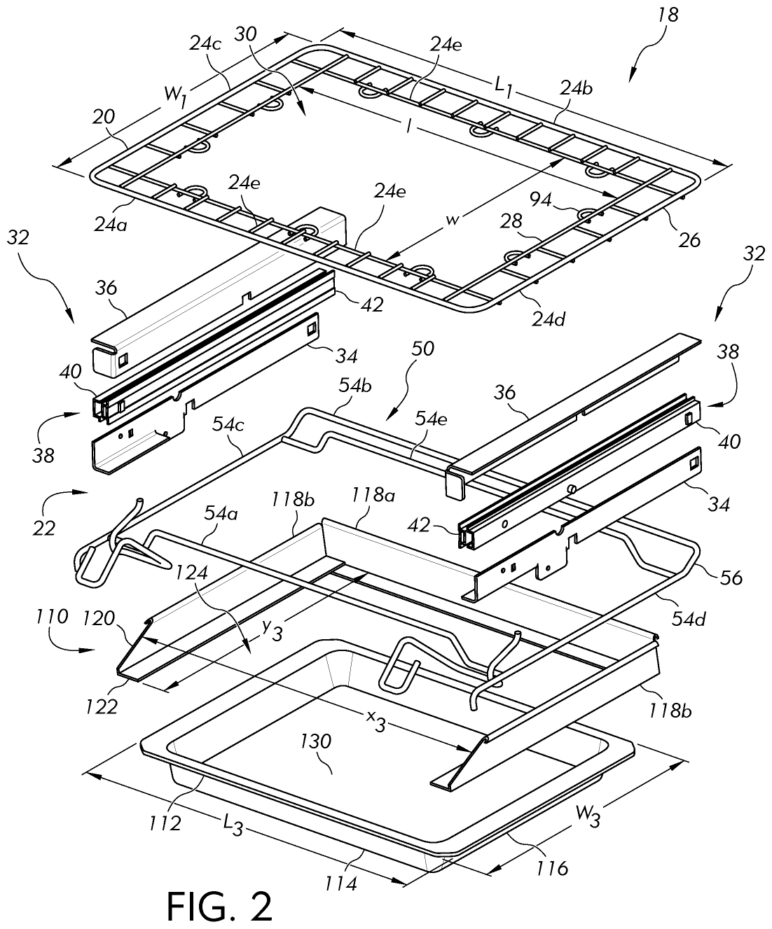

Referring to FIGS. 1 and 2, an appliance 10 is illustrated having a cavity 12 defined by a plurality of walls 14 including an upper wall 14a, a lower wall 14b, a rear wall 14c, and a pair of side walls 14d. The appliance 10 further includes a door 16 for providing selective access to the cavity 12, and a rack assembly 18 mounted within the cavity 12. The rack assembly 18 includes a slide rack 20 and a mounting assembly 22 for slidably mounting the slide rack 20 within the cavity 12 of the appliance 10.

The appliance 10 in the illustrated embodiment corresponds to an oven appliance that is operable to perform one or more cooking operations (e.g., baking, broiling, etc.). For example, the appliance 10 can include one or more heating elements (e.g., gas burners or electric-resistive heating elements) within or outside of the cavity 12 that are independently or collectively operable to heat the cavity 12 to a predetermined temperature. The heating element(s) can be operated to maintain the cavity 12 at the predetermined temperature for a predetermined amount of time and/or until a user terminates the cooking operation. It is to be appreciated that a “cooking operation” of the appliance 10 can be any operation of the appliance 10 in which a temperature of the cavity 12 is elevated above ambient for a period of time. However, the appliance 10 may be a refrigerator, a freezer, or some other appliance in other embodiments.

The slide rack 20 is a rigid body that, as discussed further below, is configured to interchangeably support a plurality of rack inserts (e.g., pans, trays, baskets, supplemental racks, etc.). In the illustrated embodiment, the slide rack 20 is a “full width” rack having dimensions that approximate horizontal dimensions of the cavity 12. In particular, the slide rack 20 is a rectangular rack having a length L₁ that is nearly equal to a distance x₁ between the side walls 14d of the cavity 12, and a width W₁ that is nearly equal to a depth y₁ of the rear wall 14c of the cavity 12 from the door 16 when closed (for the purposes of this disclosure, a first dimension “approximates” or is “nearly equal” to a second dimension if the ratio between of the first and second dimensions (or its inverse) is between 0.90 and 1.0, preferably between 0.95 and 1.0). However, it is to be appreciated that the slide rack 20 may have different shapes in other embodiments.

The slide rack 20 in the illustrated embodiment is defined by a plurality of metal wires 24, which includes a front wire 24a, a rear wire 24b, opposed side wires 24c, 24d, and a plurality of cross-wires 24e. The front wire 24a, rear wire 24b, and side wires 24c, 24d collectively form a rectangular, outer frame 26 of the slide rack 20. Those wires may be joined or respective extents of the same wire to form a continuous perimeter loop defining the outer frame 26, as shown. Alternatively, they may be distinct wires joined together at their respective adjacent ends. Meanwhile, the plurality of the cross-wires 24e extend inward from the outer frame 26 and terminate at an inner frame 28 that defines a rectangular well opening 30 of the slide rack 20, preferably at the center of the slide rack 20. The well opening 30 is designed to accommodate various rack inserts when inserted therein and supported by the slide rack 20, as discussed further below.

The wires 24 of the slide rack 20 can be integrally formed from a single piece of metal wire, or separately formed and attached together in various manners such as by welding, adhesives, or fasteners. The wires 24 also can include or be made of other materials, and can be arranged differently than illustrated to form alterative shapes than those shown in the drawings. Moreover, the slide rack 20 may include other types of elements such as, for example, brackets. Broadly speaking, the slide rack 20 can be any rigid body that is slidable within the cavity 12 and defines a well opening 30 for accommodating a plurality of rack inserts.

The mounting assembly 22 includes a pair of telescoping slides 32 for slidably mounting the slide rack 20 within the cavity 12. Each slide 32 has a main portion 34 and an extension portion 36 that is fixed to the slide rack 20 and slidable relative to the main portion 34. In the illustrated embodiment, the main portion 34 and extension portion 36 of each slide 32 are elongated-metal brackets and are slidably coupled to each other via an intermediate bearing assembly 38. The bearing assembly 38 includes a first rail 40 fixed to the main portion 34, a second rail 42 fixed to the extension portion 36, and a plurality of ball bearings (not shown) between the first and second rails 40, 42 that permit the first and second rails 40, 42 to slide relative to each other. However, the main portion 34 and extension portion 36 of each slide 32 may comprise other shapes and materials, and may be slidably coupled to each other in a variety of different manners.

In some examples, the slides 32 of the rack assembly 18 can be mounted directly to the walls of the cavity 12. For instance, the main portions 34 of the slides 32 can rest directly upon ledges or guide rails 48 defined by (or attached to) the walls of the cavity 12. In addition or alternatively, the main portions 34 can be secured to the walls of the cavity 12 via fasteners (e.g., screws), latches, welding, or the like.

In other examples, the mounting assembly 22 can include a base 50 that supports the slide rack 20 and slides 32 and can be placed onto the guide rails 48 of the cavity 12 to mount the rack assembly 18 within the cavity 12. In particular, the main portions 34 of the slides 32 can be fixed to the base 50 such that the extension portions 36 of the slides 32 (and the slide rack 20 fixed to the extension portions 36) are slidable relative to the base 50. Similar to the slide rack 20, the base 50 can have a plurality of wires 54, which includes a front wire 54a, a rear wire 54b, and opposed side wires 54c, 54d that collectively define a rectangular wire subframe 56. The base 50 can further include one or more cross-wires 54e that extend across the base 50 to reinforce and mitigate sagging of the base 50. The wires 54 can be integrally formed from a single piece of metal wire, or separately formed and attached together in various manners such as by welding, adhesives, or fasteners. The wires 54 of the base 50 also can be made of or include a variety of different materials, and can be arranged in different manners than illustrated to form various other shapes. Moreover, the base 50 may be defined by other types of elements such as, for example, brackets. Broadly speaking, the base 50 can be any rigid body that supports the slides 32 and slide rack 20 described above.

The rack assembly 18 is configured such that when mounted within the cavity 12, the slide rack 20 can be slid relative to the cavity 12 and base 50 between a fully retracted position in which the slide rack 20 is located entirely within the cavity 12, and an extended position in which the slide rack 20 has been advanced forward from the fully retracted position, such that it can extend partially or completely out of the cavity 12.

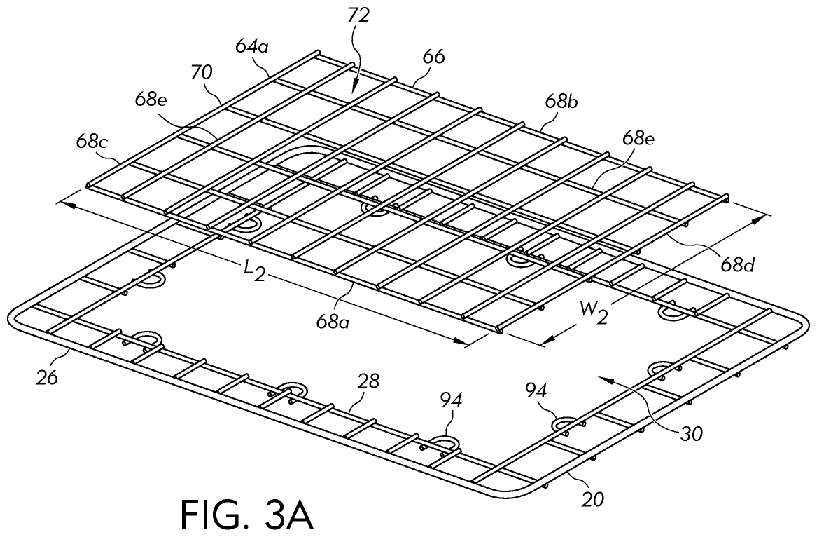

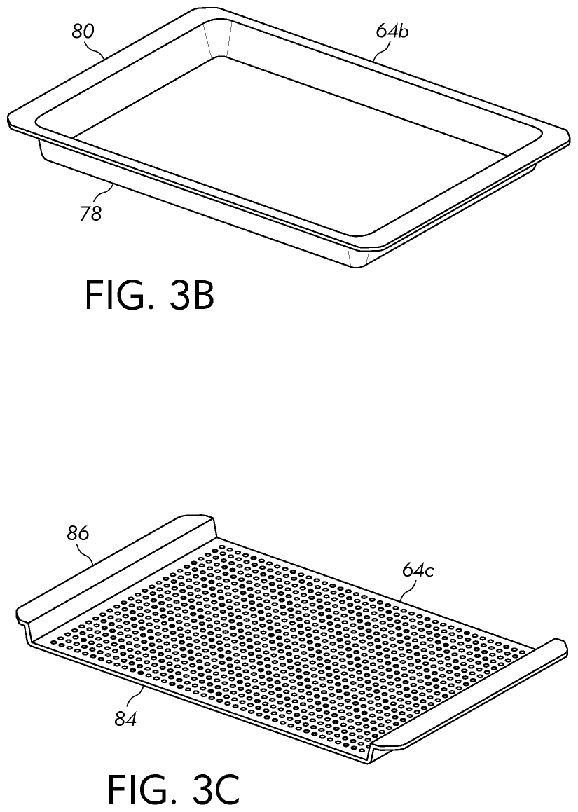

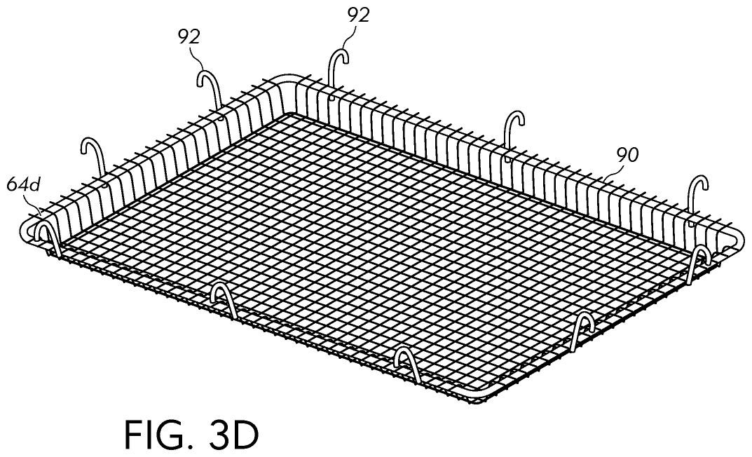

As noted above, the slide rack 20 is configured to interchangeably support a plurality of rack inserts. FIGS. 3A-3D illustrate various examples of rack inserts 64 that can be interchangeably supported by the slide rack 20.

For example, FIG. 3A illustrates a supplemental rack 64a having a wire body 66 defined by a plurality of wires 68, which includes a front wire 68a, a rear wire 68b, opposed side wires 68c, 68d, and a plurality of cross-wires 68e. The front wire 68a, rear wire 68b, and side wires 68c, 68d collectively form a rectangular outer frame 70 of the supplemental rack 64a. Moreover, the cross-wires 68e extend inward from the outer frame 70 and collectively form a support area 72 of the supplemental rack 64a.

Meanwhile, FIG. 3B illustrates a conventional “half size” cooking pan 64b that includes a pan body 78 and a laterally extending flange or lip 80 about the perimeter of the pan body 78. The flange or lip 80 is elevated from a base of the pan body 78. FIG. 3C illustrates a perforated cooking tray 64c that includes a perforated metal sheet 84 and laterally extending flanges 86 along the side edges of the sheet 84, again elevated from a base of the tray 64c. FIG. 3D illustrates a cooking basket 64d having a wire body 90 and a plurality of hooks 92 attached to the wire body 90 about a perimeter thereof.

Each rack insert 64 can be removably supported by the slide rack 20 such that the rack insert 64 is suspended over, in, or through the well opening 30 of the slide rack 20. Moreover, the slide rack 20 and rack inserts 64 can include various types of coupling elements (e.g., brackets, flanges, tabs, hooks, wires, grooves, recesses, projections, etc.) that can engage each other to removably couple each rack insert 64 to the slide rack 20.

For example, the cooking basket 64d can be inserted through the well opening 30 of the slide rack 20 and hooked to the inner frame 28 using the hooks 92 depending from the cooking basket 64d. When hooked to the slide rack 20, the cooking basket 64d will hang below the well opening 30 at a depth corresponding to the length of the hooks 92.

As another example, the slide rack 20 in the illustrated embodiment (FIG. 3A) includes a plurality of tabs 94 that are fixed to and extend inward from the inner frame 28. The tabs 94 are configured to engage and support corresponding structure of a rack insert 64 when the rack insert 64 inserted in the well opening 30. For instance, the supplemental rack 64a can be removably supported by the slide rack 20 by inserting the supplemental rack 64a in the well opening 30 so that its outer frame 70 rests on the tabs 94. Similarly, the cooking pan 64b can be inserted in the well opening 30 such that its lip 80 rests on the tabs 94. As well, the cooking tray 64c can be inserted such that its flanges 86 rest on the tabs 94.

One or more of the rack inserts 64 can have dimensions that approximate the dimensions of the well opening 30, such that the rack insert 64 will fit securely in the well opening 30 when mounted. For example, the outer frame 70 of the supplemental rack 64a in the illustrated embodiment is rectangular in shape and has a length L₂ that is nearly equal to a length l of the well opening 30, and a width W₂ that is nearly equal to a width w of the well opening 30. Accordingly, when the supplemental rack 64a is placed on the tabs 94 of the slide rack 20 in the well opening 30, the supplemental rack 64a will fit securely within the inner frame 28 of the slide rack 20, and will be constrained from shifting laterally. Moreover, the slide rack 20 and supplemental rack 64a will collectively form a continuous surface on which other elements (e.g., cooking trays, baking pans, etc.) can be placed. In particular, the cross-wires 68e of the supplemental rack 64a can align with the cross-wires 24e of the slide rack 20 such that the support area 72 of the supplemental rack 64a is continuous with and extended by the cross-wires 24e of the slide rack 20.

The cooking pan 64b, cooking tray 64c, and cooking basket 64d may be similarly dimensioned to fit securely within the well opening 30 when inserted in the well opening 30.

The plurality of rack inserts 64 supportable by the slide rack 20 can include additional or alternative rack inserts than those described above such as for example, glass baking pans, cooking trays with muffin insets, or non-perforated cooking trays. In some examples, the rack inserts 64 can all be substantially different from each other, such that each rack insert 64 is unique in structure and function. Alternatively, some rack inserts 64 may be similar in type to each other but vary in regards to material, coatings, size, thickness, and/or shape.

As can be appreciated from the above, the rack assembly 18 can accommodate a variety of different applications by altering which rack insert 64 is supported by the slide rack 20 based on the intended application. For instance, the supplemental rack 64a in FIG. 3A can be used to form a continuous support rack surface as noted above, which can be used like a conventional oven rack to support baking pans, cooking trays, etc. Alternatively, the supplemental rack 64a can be removed and replaced with a specialty rack insert 64 such as one of the rack inserts 64b-d described above. In particular, the cooking pan 64b can be used to bake meats or deep-dish meals, the cooking tray 64c can be used to bake cookies and various pastries, and the cooking basket 64d can be used to grill or ‘air fry’ various food items.

The well opening 30 in the slide rack 20 lowers the thermal mass of the rack assembly 18 as compared to a similar rack assembly having a conventional oven rack. This reduction in thermal mass is particularly advantageous for applications in which the rack assembly 18 is mounted within a temperature-controlled cavity (e.g., oven cavity or refrigerator compartment), since the reduction in thermal mass will reduce the energy needed to achieve and maintain a desired temperature for the cavity. Accordingly, the overall thermal mass of the rack assembly 18 and rack insert 64 can be tailored for each application by selecting the appropriate rack insert 64 for the application, thereby contributing only so much thermal mass as appropriate for the application.

Preferably, the slide rack 20 will have a relatively large well opening 30 in order to reduce the rack assembly's thermal mass as much as possible. For example, the slide rack 20 can have a well opening area that is preferably 50% or more, and more preferably 60% or more, of the rack's total superficial area calculated by multiplying its overall length (L₁) and width (W₁) dimensions for a substantially square or rectangular rack; i.e. the total area bound by the rack's outer perimeter.

Another advantage is that the rack assembly 18 can take advantage of rack inserts 64 already being manufactured as oven racks or oven-rack inserts for other markets where oven cavities (and therefore racks) are smaller. For example, oven cavities in the US are much larger than those in Europe and therefore, US oven racks also are larger than European ones. However, an oven rack or oven-rack accessory manufactured for use in a European-spec oven can now also be used in a US-spec oven as one of the rack inserts 64 disclosed herein, where it will be supported by the slide rack 20, which is sized to correspond to the US oven cavity. That is, the slide rack 20 of the rack assembly 18 can be dimensioned to approximate horizontal dimensions of a first cavity of a first appliance (e.g., a North American oven), while the rack inserts 64 supportable by the rack assembly 18 can be dimensioned to approximate dimensions of both the well opening 30 of the rack assembly 18 and a second cavity of a second appliance (e.g., a European oven) that is smaller than the first cavity. In this manner, racks and rack inserts already being manufactured for other markets now can see double duty as the rack inserts 64 disclosed herein, opening up a new market for existing products and taking advantage of economies of scale in manufacture.

For example, as discussed above the rack assembly 18 in the illustrated embodiment is configured to be mounted within the cavity 12 of the appliance 10, and the slide rack 20 of the rack assembly 18 is dimensioned to approximate horizontal dimensions of the cavity 12. In particular, the slide rack 20 has a length L₁ that is nearly equal to the distance x₁ between the side walls 14d of the cavity 12, and a width W₁ that is nearly equal to the depth y₁ of the rear wall 14c of the cavity 12 from the door 16 when closed. Moreover, the supplemental rack 64a is dimensioned to approximate dimensions of the well opening 30. In particular, the supplemental rack 64a has a length L₂ that is nearly equal to the length l of the well opening 30, and a width W₂ that is nearly equal to the width w of the well opening 30.

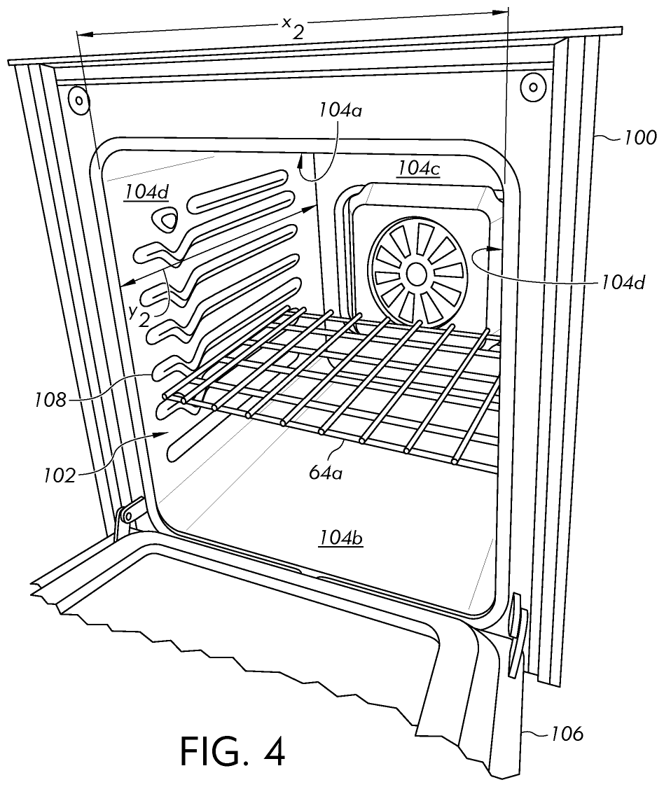

The dimensions of the rack assembly 18 and supplemental rack 64a can be predetermined such that the supplemental rack 64a fits not only within the well opening 30 of the rack assembly 18, but can also be mounted within a second cavity of a second appliance that is smaller than the cavity 12 of the appliance 10 above. For example, FIG. 4 shows a second appliance 100 having a cavity 102 defined by a plurality of walls 104 including an upper wall 104a, a lower wall 104b, a rear wall 104c, and a pair of side walls 104d. The appliance 100 further includes a door 106 for providing selective access to the cavity 102. Notably, a distance x₂ between the side walls 104d of the cavity 102 is less than the distance x₁ between the side walls 14d of the cavity 12 described above, and a depth y_{z} of the rear wall 104c of the cavity 102 from its door 106 is less than the depth y₁ of the rear wall 14c of the cavity 12 from its door 16.

The supplemental rack 64a can be mounted within the cavity 102 by placing the supplemental rack 64a onto ledges or guide rails 108 defined by (or attached to) the side walls 104d of the cavity 102. Moreover, the supplemental rack 64a can be dimensioned to approximate horizontal dimensions of the cavity 102. In particular, the length L₂ of the supplemental rack 64a can be nearly equal to the distance x₂ between the side walls 104d of the cavity 102, while the width W₂ of the supplemental rack 64a can be nearly equal to the depth y_{z} of the rear wall 104c of the cavity 102 from its door 106 when closed.

Thus, the rack assembly 18 can promote scaling of manufacture of the supplemental rack 64a, because the supplemental rack 64a can be used in both cavities 12 and 102 of the respective appliances 10 and 100. In particular, the appliance 10 and rack assembly 18 can be supplied to a first geographic market (e.g., U.S.), the appliance 100 can be supplied to a second geographic market (e.g., Europe), and a plurality of identical supplemental racks 64a can be made together on the same assembly line and supplied to both markets for use with both appliances 10, 100. Moreover, any of the other rack inserts 64 described above can be similarly dimensioned such that the rack inserts 64 are both directly mountable in the cavity 102 of appliance 100 and supportable by the rack assembly 18 within the cavity 12 of appliance 10.

In some examples, the rack assembly 18 can include an auxiliary support 110 that is coupled to the base 50 and configured to support an auxiliary rack insert 112, as shown in FIGS. 1 and 2.

In the illustrated embodiment, the auxiliary rack insert 112 is a rectangular pan having a pan body 114 and a flange or lip 116 that surrounds the perimeter of the pan body 114. Meanwhile, the auxiliary support 110 is defined by a plurality of metal brackets 118, which includes a rear bracket 118a and a pair of opposed side brackets 118b that extend forward from opposite ends of the rear bracket 118a to form a U-shaped body. Each bracket 118 of the auxiliary support 110 is fixed to the base 50 and has a vertical portion 120 that extends downward from the base 50. Moreover, each bracket 118 includes a flange portion 122 that extends inward from a bottom end of its vertical portion 120, perpendicular to the vertical portion 120. The U-shaped auxiliary support 110 defines an interior space 124.

The auxiliary rack insert 112 can be removably supported by the auxiliary support 110 by inserting the rack insert 112 into the interior space 124 and resting its lip 116 on the flange portions 122 of the auxiliary support 110. Moreover, the rack insert 112 can be dimensioned to approximate dimensions of the auxiliary support 110. In particular, the rack insert 112 can be rectangular and have a length L₃ that is nearly equal to a distance x₃ between the vertical portions 120 of the side brackets 118b, and a width W₃ that is nearly equal to a distance y₃ of the rear bracket 118 from the front ends of the side brackets 118b.

When supported by the auxiliary support 110, the auxiliary rack insert 112 can be disposed directly below the well opening 30 of the slide rack 20 (in its fully retracted state). In this manner, the auxiliary rack insert 112 can function as a crumb or drip tray that catches crumbs, grease or other foodstuff that fall from the rack insert 64 mounted to the primary slide rack 20 above. Moreover, water can be poured into the pan body 114 of the auxiliary rack insert 112 prior to initiating a cooking operation (e.g., broiling, baking, etc.) of the appliance 10. In particular, water can be poured into the pan body 114 such that the water covers a base 130 of the pan body 114 (e.g., with a depth of ¼ inch or more). A food item can then be placed directly on the rack insert 64 above (e.g., with no intermediate cooking utensil or wrapping), and a cooking operation can be initiated that heats the cavity 12 to cook the food item. By adding water into the pan body 114 prior to the cooking operation, smoke generated from crumbs, grease or other foodstuff falling into and contacting the pan body 114 during the cooking operation can be reduced. For example, when cooking proteins such as poultry or meat, fat is liquified and can drip from the food item through the rack insert 64 as grease. If that grease lands on a dry surface in a hot oven it will generate smoke. By configuring the auxiliary rack insert 112 as a drip pan and filling it with water, the grease drippings can fall into water, thereby preventing the drippings from directly contacting dry surfaces within the cavity 12 and thus from generating smoke while cooking the food item.

Preferably, the auxiliary rack insert 112 is larger in dimensions than the well opening 30 so that the auxiliary rack insert 112 extends under the entire well opening 30. For example, the length L₃ of the rack insert 112 preferably is larger than the length/of the well opening 30, and the width W₃ of the rack insert 112 is preferably larger than the width w of the well opening 30.

However it is to be appreciated that the auxiliary support 110 and rack insert 112 may comprise other shapes, sizes, and materials than those described above. Moreover, the rack insert 112 may correspond to a different type of rack insert such as, for example, any of the other rack inserts 64 described above. In some examples, the auxiliary rack insert 112 can be fixed to the auxiliary support 110, or removably coupled to the auxiliary support 110 by means other than those described above. Still further, the auxiliary support 110 may be slidably coupled to the base 50, similar to the primary slide rack 20.

In some examples, the rack assembly 18 may include a plurality of auxiliary rack inserts 112 that can be interchangeably supported by the auxiliary support 110. The rack inserts 112 can all be substantially different from each other, such that each rack insert 112 is unique in structure and function. Alternatively, some rack inserts 112 may be similar in type to each other but vary in regards to material, coatings, size, thickness, and/or shape.

The invention has been described with reference to example embodiments described above. Modifications and alterations will occur to others upon a reading and understanding of this specification. Example embodiments incorporating one or more aspects described above are intended to include all such modifications and alterations insofar as they come within the scope of the appended claims.

What is claimed is:

1. A rack assembly that is mountable within a cooking cavity of an appliance, the rack assembly comprising:
a slide rack defining a well opening and configured to removably support a rack insert in or through said well opening; and
a telescoping slide coupled to said slide rack such that said slide rack is slidable between a fully retracted position and a forward position relative to said cooking cavity when mounted therein.

2. The rack assembly of claim 1, further comprising a plurality of rack inserts, each of said plurality of rack inserts being different from the others and being interchangeably supportable by the slide rack in or through the well opening.

3. The rack assembly of claim 2, wherein one or more of the plurality of rack inserts comprises a pan, a tray, a basket, or a supplemental rack.

4. The rack assembly of claim 2, wherein one or more of the plurality of rack inserts has dimensions approximating dimensions of the well opening.

5. The rack assembly of claim 1, the slide rack being defined by a plurality of wires.

6. The rack assembly of claim 5, the slide rack being planar and rectangular in shape.

7. The rack assembly of claim 5, the plurality of wires defining a rectangular outer frame and a rectangular inner frame surrounding said well opening, the inner frame being coplanar with and spaced inward from the outer frame.

8. The rack assembly of claim 1, further comprising a base configured to mount the rack assembly in said cooking cavity, said slide rack being coupled to said base via said telescoping slide.

9. The rack assembly of claim 8, said telescoping slide comprising:
a main portion fixed to the base, and
an extension portion fixed to the slide rack and slidably coupled to the main portion.

10. The rack assembly of claim 8, the base being defined by a plurality of wires.

11. The rack assembly of claim 8, further comprising an auxiliary rack insert and an auxiliary support coupled to the base for removably supporting the auxiliary rack insert beneath the well opening in the slide rack when the slide rack is fully retracted.

12. The rack assembly of claim 11, the auxiliary support being defined by a plurality of brackets, each said bracket having a vertical portion that extends downward from the base and a flange portion that extends inward from the vertical portion.

13. The rack assembly of claim 11, the auxiliary rack insert having larger dimensions than the well opening.

14. A method of cooking in a cooking cavity having the rack assembly of claim 11 mounted therein, said auxiliary rack insert being a pan, the method comprising:
filling the pan with water;
placing a food item on said rack insert mounted in or through said well opening in the slide rack; and
heating the cooking cavity to cook said food item on said rack insert therein, whereby drippings from said food item fall through said rack insert and into the water in said pan, thereby preventing said drippings from directly contacting dry surfaces within the cooking cavity and thus from generating smoke while cooking said food item.

15. The method of claim 14, said food item being placed directly onto said rack insert with no intermediate cooking utensil or wrapping.

16. The rack assembly according to claim 1, said slide rack having a well opening area that is 50% or more of a total superficial area of the slide rack.

17. A cooking appliance comprising a cooking cavity and the rack assembly of claim 1 mounted within the cooking cavity, wherein the slide rack is fully received within said cooking cavity when in the fully retracted position and emerges at least partially from said cooking cavity when in the forward position; an area of said well opening being 50% or more of a total superficial area of the slide rack.

18. A method of manufacturing cooking appliances, comprising:
supplying a first cooking appliance having a first cooking cavity with first horizontal dimensions;
supplying a second cooking appliance having a second cooking cavity with second horizontal dimensions smaller than the first horizontal dimensions;
supplying a rack assembly for the first cooking appliance, said rack assembly being configured to be mounted in said first cooking cavity and comprising a slide rack that defines a well opening therein and is configured to removably support a rack insert in or through said well opening, the slide rack having slide rack dimensions that approximate said first horizontal dimensions; and
supplying a plurality of said rack inserts, identical to one another, having insert dimensions that approximate the second horizontal dimensions of the second cooking appliance as well as well opening dimensions of the well opening.

19. The method of claim 18, further comprising supplying the first cooking appliance to a first geographic market, and supplying the second cooking appliance to a second geographic market distinct from the first geographic market.

20. The method of claim 18, wherein a first subset of said rack inserts is packaged respectively with individual units of said second cooking appliance, and a second subset of said rack inserts is packaged respectively with individual units of said rack assembly.

21. The method of claim 18, said slide rack having a well opening area that is 50% or more of a total superficial area of the slide rack.
